(19) United States
(12) Patent Application Publication
(10) Pub. No.: US 2008/0113743 A1
(43) Pub. Date: May 15, 2008

(54) Systems and methods of conducting a game of chance

(75) Inventors: Vladimir Dunaevsky, Toronto (CA); Justin L. Thouin, Toronto (CA)

Correspondence Address: BERESKIN AND PARR, 40 KING STREET WEST, BOX 401, TORONTO, ON, M5H 3Y2, omitted

(73) Assignee: CryptoLogic Inc., Toronto (CA)

(21) Appl. No.: 11/599,309

(22) Filed: Nov. 15, 2006

(51) Int. Cl. A63F 13/00

(52) U.S. Cl. 463/20; 463/25; 463/42

(57) ABSTRACT

Systems and methods of conducting a video game of chance are disclosed. The method includes:

a) receiving a wager;

b) populating a number of cell images with a game symbol;

c) determining whether any portion of the cells define a winning combination; and

d) in the event the winning combination occurs:
i) providing a predetermined award for the winning combination;
ii) deleting the symbol located in each winning cell image;
iii) repopulating each winning cell with a replacement symbol; and

e) repeating steps (c) and (d) until no winning combinations are defined by the symbols appearing in the cell images.

### FIELD OF THE INVENTION

The present invention relates to games of chance. In particular, the invention relates to a game of chance implemented as a video game.

### BACKGROUND OF THE INVENTION

Playing video games is a very popular and well known entertainment activity. There is a large variety of video games available to consumers. One category of video games is the games of chance category. Some examples of video games of chance include video poker and video slot games.

Slot machine games were originally designed for mechanical machines that used a number of physical rotating reels actuated by a user inserting a coin or token and pulling down on a lever.

The advent of video slot games permitted game designers to be more creative by eliminating the limitations associated with physical reels and mechanical machines. The designers were no longer limited to physical reels having a fixed number of symbols per reel. Video slot games permitted game designers to easily create any number of virtual reels with any number of symbols on each reel.

### SUMMARY OF THE INVENTION

The present invention relates generally to a video game of chance (also referred to simply as a “game”) which is loosely related to video slot machine games.

According to a first aspect of the invention, a method of conducting a video game of chance is provided. The method comprises:

a) receiving a wager;

b) populating a plurality of cells on a display with a plurality of symbols;

c) determining whether any portion of the plurality of cells define a winning combination; and

d) in the event the winning combination occurs:
i) providing a predetermined award for the winning combination;
ii) deleting the symbol located in each winning cell;
iii) repopulating each winning cell with a replacement symbol; and

e) repeating steps (c) and (d) until no winning combinations are defined by the plurality of symbols appearing in the plurality of cells.

According to a second aspect of the invention, a method of playing a video game of chance is provided. The method comprises:

a) communicating a wager;

b) displaying a plurality of cells populated with a plurality of symbols;

c) if any portion of the plurality of cells define a winning combination:
i) displaying a predetermined award for the winning combination;
ii) deleting the symbol located in each winning cell;
iii) displaying the plurality of cells, wherein each winning cell is populated with a replacement symbol; and

d) repeating step (c) until no winning combinations are defined by the plurality of symbols appearing in the plurality of cells.

According to a third aspect of the invention, a system for conducting a video game of chance is provided. The system comprises a server and a client device having a display. The client device is adapted for communication with the server. The client device is adapted to receive a wager and communicate the wager to the server. The display is adapted to display a plurality of cells populated by a plurality of symbols. The server is adapted to determine whether any portion of the plurality of cells define a winning combination. In the event the winning combination occurs, each symbol located in each cell of the winning combination is deleted and each cell in the winning combination is repopulated with a replacement symbol.

According to a fourth aspect of the invention, a computer-readable medium is provided upon which a plurality of executable instructions for a method of conducting a video game of chance are stored. The method comprises:

a) receiving a wager;

b) populating a plurality of cells on a display with a plurality of symbols;

c) determining whether any portion of the plurality of cells define a winning combination; and

d) in the event the winning combination occurs:
i) providing a predetermined award for the winning combination;
ii) deleting the symbol located in each winning cell;
iii) repopulating each winning cell with a replacement symbol; and

e) repeating steps (c) and (d) until no winning combinations are defined by the plurality of symbols appearing in the plurality of cells.

### BRIEF DESCRIPTION OF THE DRAWINGS

In the accompanying drawings:

FIG. 1 is a block diagram of a system for conducting a game of chance according to one embodiment of the present invention;

FIG. 2 is a perspective view of a standalone gaming machine for conducting a game of chance according to another embodiment of the present invention;

FIG. 3 is an illustration of the five levels of the game according to a preferred embodiment of the present invention;

FIG. 4 is an illustration of the symbols displayed by the game according to the preferred embodiment;

FIG. 5 is a flowchart illustrating the steps of a method of conducting a game of chance according to the preferred embodiment of the invention; and

FIGS. 6A-E are illustrations of an example round of game play according to the preferred embodiment.

FIGS. 7A-D are illustrations of cell matrices according to alternative embodiments of the present invention;

### DETAILED DESCRIPTION OF THE INVENTION

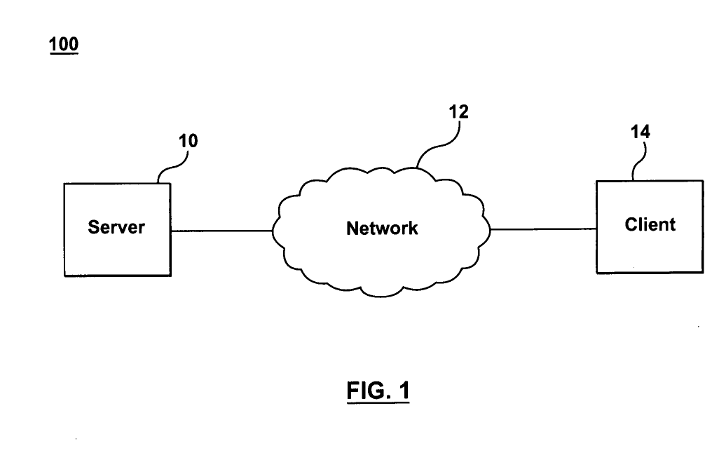

FIG. 1 shows one embodiment of the present invention where the video game of chance is implemented in a system 100. The system 100 includes a client device 14 that is connected to a host server 10 via a network 12. A player uses the client device 14 to access the game, which is hosted on the host server 10. The game is implemented electronically by software that is installed on the host server 10.

The host server 10 is preferably implemented by the use of one or more general purpose computers, such as, for example, a Sun Microsystems™ F15k server. The client device 14 is also preferably implemented by the use of one or more general purpose computers, such as, for example, a typical personal computer manufactured by Dell™, Gateway™, or Hewlett-Packard™. Those skilled in the art will understand that the client device may be a game console, a portable gaming device, a laptop computer, a personal digital assistant (PDA), a mobile phone, a set top box, or an interactive television.

Each of the host server 10 and the client device 14 may include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The host server 10 may use its microprocessor to read a computer-readable medium containing software that includes instructions for carrying out one or more of the functions of the host server 10, as further described below.

Continuing to refer to FIG. 1, each of the host server 10 and the client device 14 can also include computer memory, such as, for example, random-access memory (RAM). However, the computer memory of each of the host server 10 and the client device 14 can be any type of computer memory or any other type of electronic storage medium that is located either internally or externally to the host server 10 or the client device 14, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like.

According to exemplary embodiments, the respective RAM can contain, for example, the operating program for either the host server 10 or the client device 14. As will be appreciated based on the following description, the RAM can, for example, be programmed using conventional techniques known to those having ordinary skill in the art of computer programming. The actual source code or object code for carrying out the steps of, for example, a computer program can be stored in the RAM.

Each of the host server 10 and the client device 14 can also include a database. The database can be any type of computer database for storing, maintaining, and allowing access to electronic information stored therein.

The host server 10 preferably resides on a network 12, such as a local area network (LAN), a wide area network (WAN), or the Internet. The client device 14 preferably is connected to the network 12 on which the host server 10 resides, thus enabling electronic communications between the host server 10 and the client device 14 over a communications connection, whether locally or remotely, such as, for example, an Ethernet connection, an RS-232 connection, or the like.

The client device 14 typically includes a monitor or other display for displaying the actions and status of the video game. The client device 14 may be configured to accept user inputs provided via, for example, a keyboard, a mouse, and a joystick, or touchscreen.

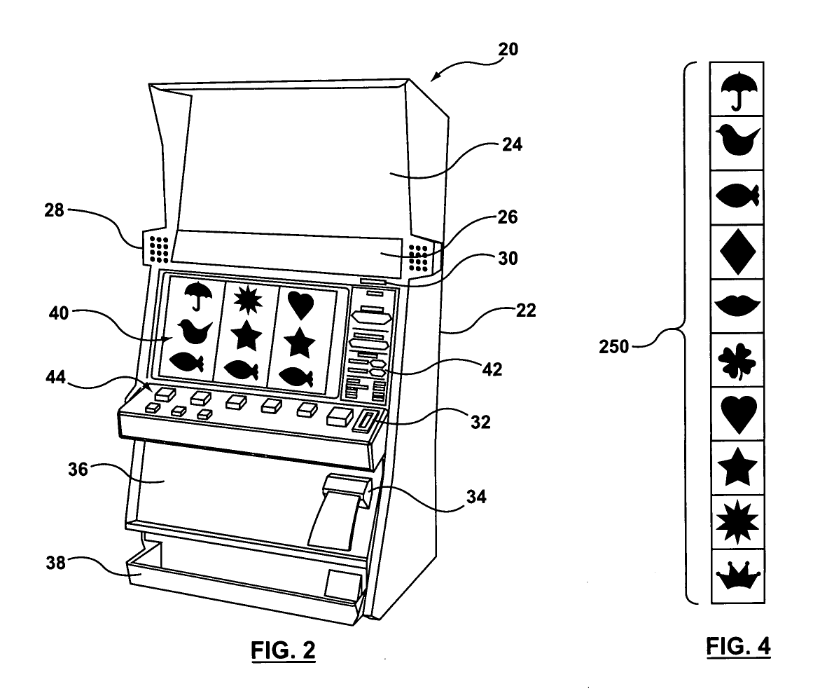

FIG. 2 shows another embodiment of the present invention where the video game of chance may be implemented on a standalone gaming machine, such as a video slot machine 20. The slot machine 20 is housed in a cabinet 22. The slot machine includes a reference plate 24 that identifies the type of game played on the slot machine 20, a name plate 26, speakers 28, a bill acceptor 30, a coin slot 32, a ticker slot 34 for coinless play, belly art plate 36, and a coin tray 38. The slot machine 20 also includes a video display 40, game playing instructions plate 42, and game function buttons 44.

Those skilled in the art will understand that the video game of chance may be implemented on a wide variety of other standalone gaming devices, such as game consoles, portable gaming devices, personal computers, laptop computers, personal digital assistants (PDAs), mobile phones, set top boxes, and interactive televisions.

The method of conducting a video game of chance according to a preferred embodiment of the present invention will now be described with reference to FIGS. 1-5.

The display 40 of the video slot machine 20 or the display of the client device 14 (depending of the embodiment of the invention) is configured to display any suitable number of cells preferably arranged in a N×M matrix, where N represents the number of rows in the matrix and M represents the number of columns in the matrix. The columns of cells in the matrix may be displayed as reels in a virtual slot machine.

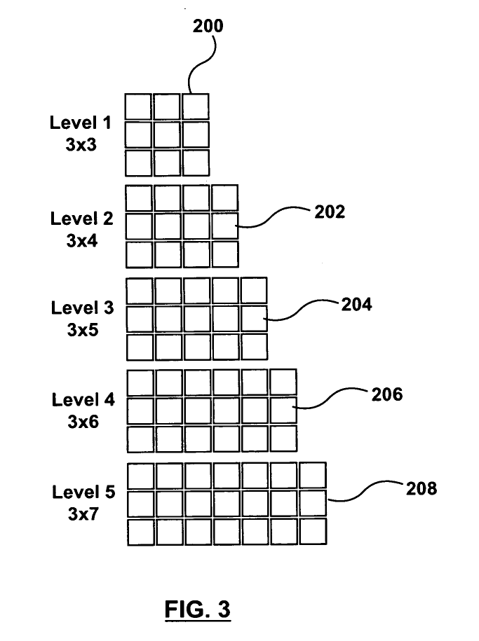

In a preferred embodiment, the game rules permit the player to progress through five levels, where each level in the order is made up of a matrix containing a progressively larger number of cells. As shown in FIG. 3, the first level matrix 200 contains nine cells arranged in a 3×3 matrix. The second level matrix 202 contains twelve cells arranged in a 3×4 matrix. The third level matrix 204 contains fifteen cells arranged in a 3×5 matrix. The fourth level matrix 206 contains eighteen cells arranged in a 3×6 matrix. The fifth and final level 208 contains 21 cells arranged in a 3×7 matrix. The purpose of the levels and rules for progression will be described in detail below.

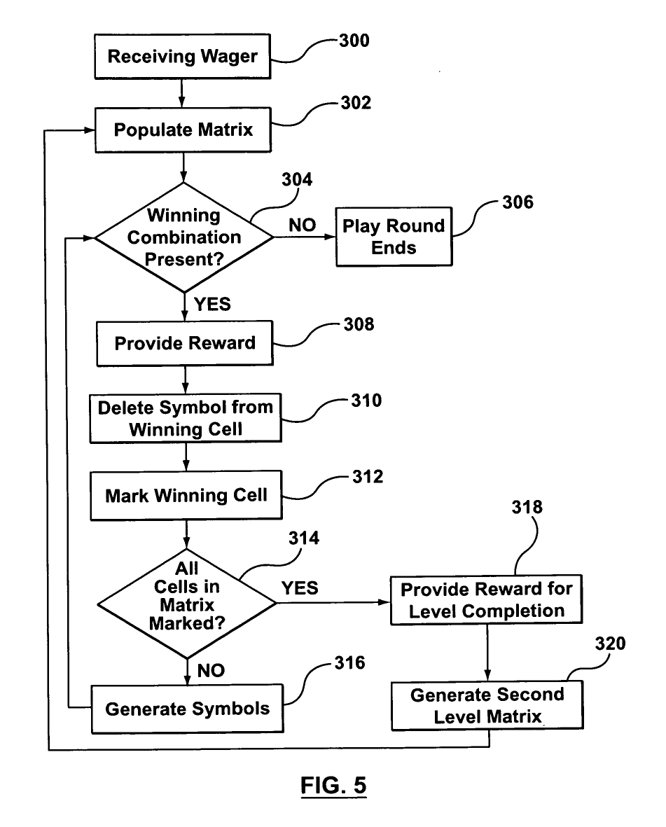

During game play, each cell is preferably populated by a symbol which may be randomly generated by video slot machine 20 or by server 10. The various symbols 250 that may be generated in the game are shown in FIG. 4.

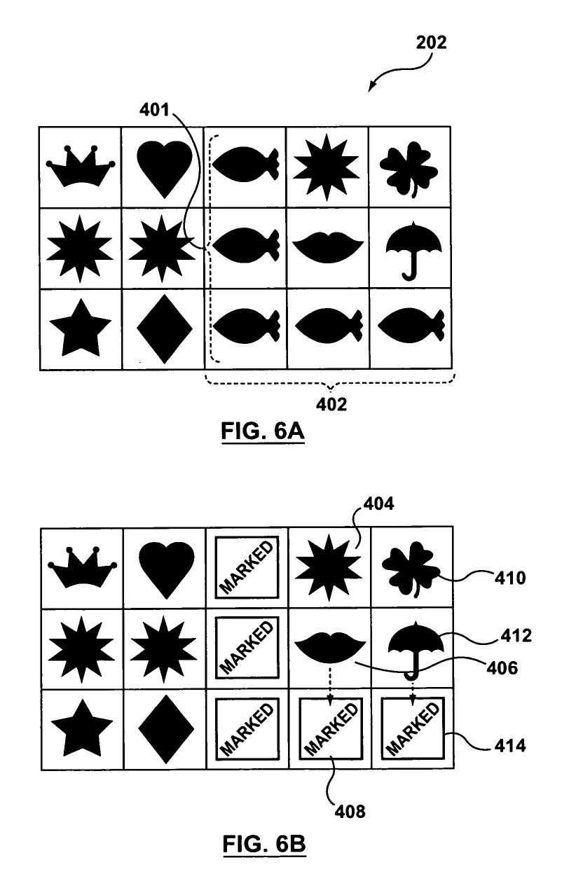

Referring now to FIGS. 1 and 5, the method begins at step 300 where a wager made by the player is received by the video slot machine 20 or by the server 10. Receipt of the wager commences the first round of play on the first level matrix 200.

Referring to FIGS. 3-5, at step 302, preferably each cell in the first level matrix 200 is populated by one of the symbols 250.

At decision diamond 304, the video slot machine 20 or server 10 determines whether a winning combination of cells is present in the first level matrix 200. Preferably, the winning combination requires three or more adjacent cells populated by an identical symbol. The winning combination of cells may be oriented vertically (i.e. along a column—also referred to as column-wise) or horizontally (i.e. along a row—also referred to as row-wise). It will be understood by those skilled in the art that any other suitable winning combination (such as diagonally adjacent cells) may be incorporated into the game to either replace or add to the above winning combinations.

If a winning combination is present, the method proceeds to step 308 where the video slot machine 20 provides a reward to the player preferably in accordance with the table below. In the embodiment of FIG. 1, the client device 14 displays the award to the player, while the server credits the award to the player's account or the like. Preferably, the award in either embodiment is a monetary award equal to a multiple of the player's wager. The multiple for each winning combination is set out in the table below. It will be understood by those skilled in the art that any other type of award may be provided, such as additional credits to play the game.

| | Symbol | | | | | |
|---|---|---|---|---|---|---|
| Symbol | name | 7 of | 6of | 5 of | 4 of | 3 of |
| [symbol] | Crown | 1000 | 500 | 300 | 200 | 100 |
| [symbol] | Sun | 500 | 300 | 200 | 100 | 75 |
| [symbol] | Star | 250 | 150 | 100 | 75 | 50 |
| [symbol] | Heart | 150 | 100 | 75 | 50 | 20 |
| [symbol] | Clover | 100 | 75 | 50 | 20 | 10 |
| [symbol] | Lips | 75 | 50 | 25 | 10 | 3 |
| ♦ | Diamond | 50 | 30 | 20 | 3 | 1 |
| [symbol] | Fish | 50 | 30 | 20 | 3 | 1 |
| [symbol] | Bird | 30 | 15 | 7 | 2 | 0.5 |
| [symbol] | Umbrella | 30 | 15 | 7 | 2 | 0.5 |

Prizes for level completion

| Level 1 | Level 2 | Level 3 | Level 4 | Level 5 |
|---|---|---|---|---|
| 21 | 18 | 13 | 9 | 7 |

Some of the combinations shown in the above table cannot be obtained on the first level matrix 200, and can only be attained is subsequent levels. For example, seven stars may only be obtained in the fifth level matrix 208.

Due to the increased payouts of combinations comprising certain symbols (such as crowns), the random symbol generator algorithm is preferably implemented in such a manner that the symbols with the higher payouts occur less frequently than symbols with lower payouts.

Referring again to FIG. 5, at step 310, the symbol in each cell of the winning combination (referred to as a “winning cell”) is deleted leaving each winning cell empty.

At step 312, each winning cell is preferably marked in any suitable way. For example, a gold border may be displayed along the edges of each winning cell.

At decision diamond 314, the video slot machine 20 or server 10 determines whether all of the cells in the first level matrix 200 have been marked.

If all of the cells in the first level matrix 200 have not been marked, the method proceeds to step 316. If one or more non-winning cells are located in the same column above a winning cell, the symbols located in the non-winning cells preferably drop down in sequence to populate any winning cells below. New symbols are then generated in any cells vacated by the dropping symbols. If no non-winning cells are located in the same column above a winning cell, then a new symbol is simply generated in the winning cell. The method then returns to decision diamond 304. If there are additional winning combinations, any previously unmarked winning cells are marked.

If all of the cells in the first level matrix 200 have been marked, the method proceeds to step 318, where the player receives an award for completing the first level. The award is preferably a multiple of the player's wager. The multiples for the level completion awards for each level are set out in the above table.

At step 320, the first level matrix 200 is deleted and replaced with the second level matrix 202. The play then returns to step 302. The play may proceed to the third, fourth, and fifth level in the same manner.

If there are no wining combinations in the first level matrix 200, the method proceeds to step 306 where the first round of play ends. The player may begin another round of play by making another wager. If any of the cells from winning combinations in previous rounds have been marked, such cells may remain marked to permit the player to continue playing in order to accumulate marked cells and complete a particular level (such as the first level matrix 200), when all cells in a particular level matrix are marked.

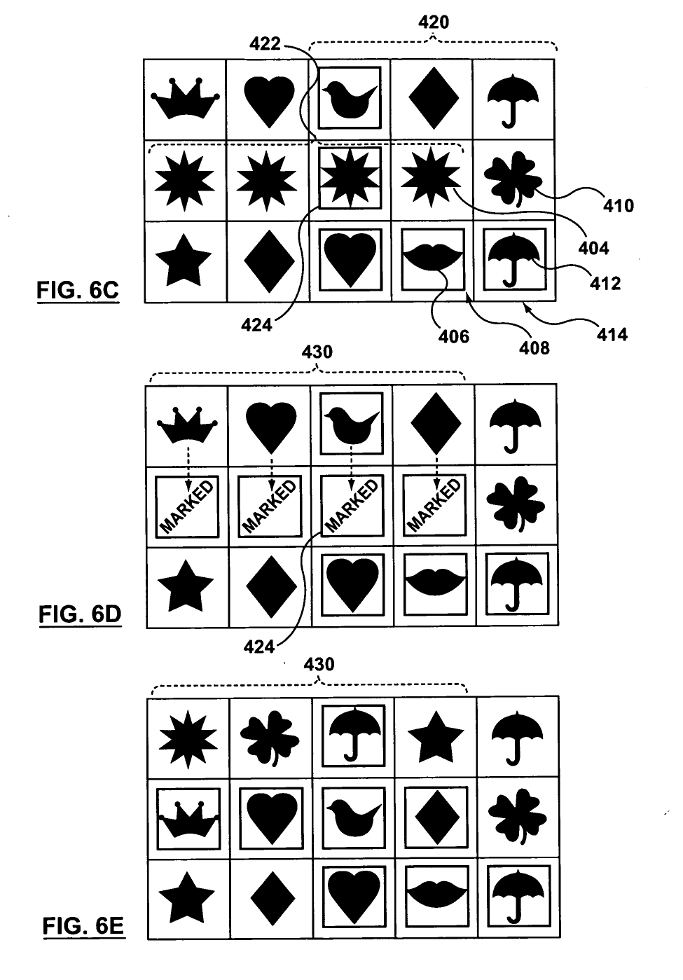

To more clearly describe and illustrate the method of conducting a video game of chance according to a preferred embodiment of the present invention, an example is provided with reference to FIGS. 6A-E. The example illustrated in FIGS. 6A-E demonstrates one round of game play on the third level matrix 204.

FIG. 6A shows the symbols populating the second level matrix 202 after receipt of the wager. Two winning combinations are shown in FIG. 6A. The first is a vertical winning combination 401 of three fish symbols. The second is a horizontal winning combination 402 also of three fish symbols.

FIG. 6B shows that the cells containing the winning combinations are marked and the symbols deleted from the winning cells. FIG. 6B also shows the lips symbol 406 dropping downward to fill the empty winning cell 408. In turn, the sun symbol 404 drops into the cell previously occupied by the lips symbol 406. Likewise, the clover symbol 410 and umbrella symbol 412 drop downward to fill the empty winning cell 414.

FIG. 6C shows the position of the lips symbol 406 and umbrella symbol 412 in the winning cells 408 and 414, respectively. FIG. 6C also shows that the sun symbol 404 and the clover symbol 410 have shifted down by one row. A new diamond and umbrella symbol have been generated in two uppermost cells 420. The foregoing movement and generation of symbols creates a new winning combination 422 of four suns in the middle row of the matrix.

Referring to FIG. 6D, the cells in the winning combination 422 are deleted and marked (with the exception of cell 424 which was previously marked). FIG. 6D also shows symbols from a group of cells 430 in the top row dropping down to fill the corresponding empty cells of winning combination 422.

FIG. 6E shows that new symbols are generated in the group of cells 430. No new winning combinations occur in the symbol arrangement shown in FIG. 6E. Accordingly, the play round comes to an end. Preferably, an additional wager is required to begin a subsequent game round. If the player chooses to make a wager and begin the subsequent game round, preferably all cells are re-populated with new symbols, but previously marked cells remain marked. The player continues on the same level matrix where the previous game round ended.

Alternatively, the player may be given an option to begin a completely new game (i.e. starting on the first level matrix 200 with no cells marked).

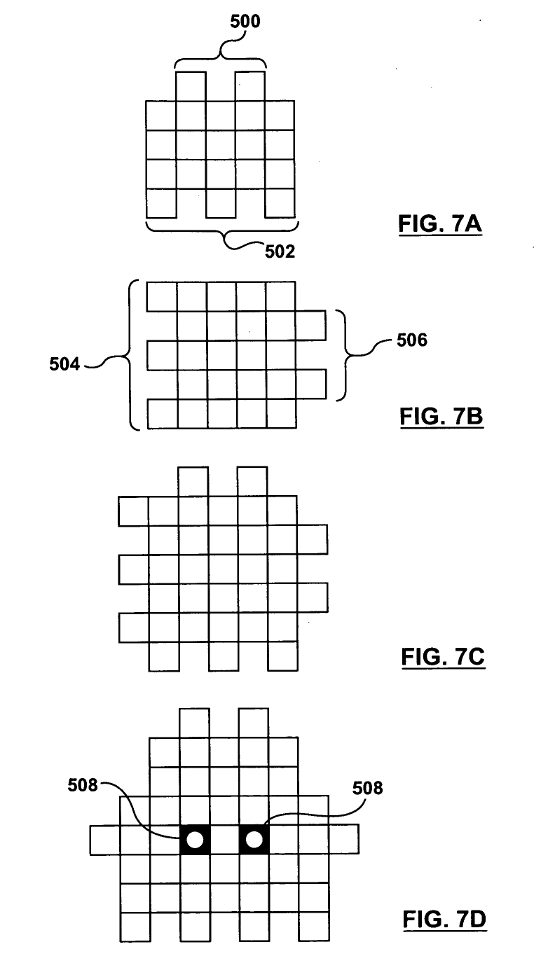

FIGS. 7A-D illustrate alternative embodiments of the present invention. In particular, FIGS. 7A-D show various non-rectangular cell matrices.

Referring to FIG. 7A, a matrix may be provided with a non-contiguous top row 500 and bottom row 502. In this embodiment, row-wise winning combinations cannot be achieved in the top and bottom rows 500, 502. Otherwise, game play proceeds in the same manner as the preferred embodiment.

Referring to FIG. 7B, a matrix may be provided with non-contiguous columns 504, 506. In this embodiment, column-wise winning combinations cannot be achieved in columns 504, 506. In addition, if any cells in columns 504, 506 are winning cells (due to such cells being part of a row-wise winning combination), symbols from above do not drop into such cells to repopulate them. New symbols are simply generated in such cells.

The matrix shown in FIG. 7C includes non-contiguous rows and columns. It combines the features of the matrices of FIGS. 7A and 7B described above. Accordingly, it will not be further described.

Referring to FIG. 7D, a matrix may be provided which, in addition to non-contiguous rows and columns, includes one or more “blocked cells” 508. As used herein, the term “blocked cells” means cells which are blocked from being populated by game symbols. Blocked cells affect game play by creating non-contiguous rows and columns in those rows and columns where such blocked cells are located. Accordingly, winning combinations may only be achieved in contiguous cells (i.e. those not broken up by a blocked cell). Repopulation is also affected (i.e. symbols can drop down in sequence to fill a vacant winning cell only in a contiguous column).

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of conducting a video game of chance comprising:
a) receiving a wager;
b) populating a plurality of cells with a plurality of symbols;
c) determining whether any portion of the plurality of cells define a winning combination; and
d) if the winning combination occurs:
i) providing a predetermined award for the winning combination;
ii) deleting the symbol located in each winning cell;
iii) repopulating each winning cell with a replacement symbol; and
e) repeating steps (c) and (d) until no winning combinations are defined by the plurality of symbols appearing in the plurality of cells.

2. The method of claim 1, wherein the plurality of cells are arranged in a matrix, the matrix comprising a plurality of columns.

3. The method of claim 2, wherein the plurality of cells are arranged in a N×M matrix, wherein N is the number of rows in the matrix and M is the number of columns in the matrix, wherein N is an integer having a value of at least 1 and M is an integer having a value of at least 3.

4. The method of claim 3, wherein N is at least 3.

5. The method of claim 4, wherein the matrix comprises at least one blocked cell.

6. The method of claim 2, wherein the winning combination comprises at least three adjacent cells populated by an identical symbol.

7. The method of claim 6, wherein the adjacent cells are aligned row-wise or column-wise.

8. The method of claim 2, wherein, if at least one non-winning cell is located above at least one winning cell and the winning cell and the non-winning cell are in the same column, the repopulating step further comprises:
i) the symbols in each non-winning cell located above the winning cells drop down in sequence to populate any winning cells below; and
ii) generating a new symbol in each empty cell vacated by step (i).

9. The method of claim 8, further comprising marking each winning cell of each winning combination.

10. The method of claim 9, wherein, if each cell of the plurality of cells is marked, play proceeds to a subsequent level, wherein the subsequent level comprises at least one of: (i) increasing the predetermined award for the winning combination; and (ii) increasing the number of cells.

11. The method of claim 10, wherein step (ii) further comprises adding at least one additional column to the matrix.

12. The method of claim 10, wherein step (ii) further comprises adding at least one additional row to the matrix.

13. The method of claim 10, wherein a level completion award is provided upon completion of a level.

14. The method of claim 1, further comprising receiving a request to play an additional game round, wherein the additional game round comprises repeating steps (a) to (e).

15. The method of claim 14, wherein any cells marked in a previous game round remain marked in any additional game rounds within a particular level.

16. The method of claim 15, further comprising marking each unmarked winning cell of each winning combination of the additional game round.

17. A method of playing a video game of chance comprising:
a) communicating a wager;
b) displaying a plurality of cells populated with a plurality of symbols;
c) if any portion of the plurality of cells define a winning combination:
i) displaying a predetermined award for the winning combination;
ii) deleting the symbol located in each winning cell;
iii) displaying the plurality of cells, wherein each winning cell is populated with a replacement symbol; and
d) repeating step (c) until no winning combinations are defined by the plurality of symbols appearing in the plurality of cells.

18. The method of claim 17, wherein the plurality of cells are arranged in a matrix, the matrix comprising a plurality of columns.

19. The method of claim 18, wherein the plurality of cells are arranged in a N×M matrix, wherein N is the number of rows in the matrix and M is the number of columns in the matrix, wherein N is an integer having a value of at least 1 and M is an integer having a value of at least 3.

20. The method of claim 19, wherein N is at least 3.

21. The method of claim 20, wherein the matrix comprises at least one blocked cell.

22. The method of claim 18, wherein the winning combination comprises at least three adjacent cells populated by an identical symbol.

23. The method of claim 22, wherein the adjacent cells are aligned row-wise or column-wise.

24. The method of claim 18, wherein, if at least one non-winning cell is located above at least one winning cell and the winning cell and the non-winning cell are in the same column, the repopulating step further comprises:
a) the symbols in each non-winning cell located above the winning cells drop down in sequence to populate any winning cells below; and
b) generating a new symbol in each empty non-winning cell vacated by step (a).

25. The method of claim 24, further comprising marking each winning cell of each winning combination.

26. The method of claim 25, wherein, if each cell of the plurality of cells is marked, play proceeds to a subsequent level, wherein the subsequent level comprises at least one of: (i) increasing the predetermined award for the winning combination; and (ii) increasing the number of cells.

27. The method of claim 26, wherein step (ii) further comprises adding at least one additional column to the matrix.

28. The method of claim 26, wherein step (ii) further comprises adding at least one additional row to the matrix.

29. The method of claim 26, wherein a level completion award is provided upon completion of a level.

30. The method of claim 17, further comprising receiving a request to play an additional game round, wherein the additional game round comprises repeating steps (a) to (d).

31. The method of claim 30, wherein any cells marked in a previous game round remain marked in any additional game rounds within a particular level.

32. The method of claim 31, further comprising marking each unmarked winning cell of each winning combination of the additional game round.

33. A system for conducting a video game of chance, the system comprising:
a) a server; and
b) a client device adapted for communication with the server, the client device comprising a display;
wherein the client device is adapted to receive a wager and communicate the wager to the server;
wherein the display is adapted to display a plurality of cells populated by a plurality of symbols;
wherein the server is adapted to determine whether any portion of the plurality of cells define a winning combination; and
wherein, in the event the winning combination occurs, each symbol located in each cell of the winning combination is deleted and each cell in the winning combination is repopulated with a replacement symbol.

34. A computer-readable medium upon which a plurality of executable instructions for a method of conducting a video game of chance are stored, the method comprising:
a) receiving a wager;
b) populating a plurality of cells with a plurality of symbols;
c) determining whether any portion of the plurality of cells define a winning combination; and
d) in the event the winning combination occurs:
i) providing a predetermined award for the winning combination;
ii) deleting the symbol located in each winning cell;
iii) repopulating each winning cell with a replacement symbol; and
e) repeating steps (c) and (d) until no winning combinations are defined by the plurality of symbols appearing in the plurality of cells.
